(19) United States
(12) Patent Application Publication
(10) Pub. No.: US 2007/0275763 A1
(43) Pub. Date: Nov. 29, 2007

(54) Display unit with lens assembly enclosure

(76) Inventors: Michael J. Sawadski, Mount Prospect, IL (US); Daniel J. Flanagan, Mount Prospect, IL (US); Kyung T. Lim, Vernon Hills, IL (US); Karl R. Voss, Schaumburg, IL (US)

Correspondence Address: MOTOROLA INC, 600 NORTH US HIGHWAY 45, W4 - 39Q, LIBERTYVILLE, IL, 60048-5343, US

(21) Appl. No.: 11/440,882

(22) Filed: May 25, 2006

(51) Int. Cl. H04B 1/38; H04M 1/00

(52) U.S. Cl. 455/566

(57) ABSTRACT

A display unit (102) of a communication device (100) with a lens assembly enclosure is provided. The display unit includes a first lens (202) and a second lens (204) that encapsulates a display assembly (206). The first lens (202) and the second lens (204) mate to define an integral module (208). The display unit (102) also includes a display connector (302) that connects the display assembly (206) to a control circuit of the communication device (100).

### FIELD OF INVENTION

The present invention relates in general to the display units of communication devices, and more specifically, to a lens assembly enclosure for display units in communication devices.

### BACKGROUND OF INVENTION

Display units in communication devices, such as mobile phones, pagers, Personal Digital Assistants (PDAs), and the like, provide visual representations of images, text, graphics, and the like. Examples of the display units include Liquid Crystal Displays (LCDs), Organic Light Emitting Diode Displays (OLEDs), Field Emission Displays (FEDs), and Flat Panel Displays (FPDs). Typically, a display unit comprises at least one display panel and at least one lens. The lenses are used to cover the display panels, thereby providing a thin transparent shield that protects the display panels from foreign material. The lenses are individually installed on the main housing of the communication devices.

Several problems can occur during the assembly of a display unit. First, foreign material may infiltrate itself between the lenses and the display panels. Such infiltration can damage the display panels because there is no protection provided for glass, flex and other passive components of the display panels. Second, in the existing assembly, due to individual installation of lenses on the main housing air gaps can be introduced between the lenses and the display panels. Such air gaps cause the display unit to become undesirably thick. Third, a mismatch can occur between the lens artwork and the display panels. Such a mismatch skews and obstructs the display.

Accordingly, there is a need for a device that contributes to the reduction of the infiltration of foreign material; the elimination of air gaps between lenses and display panels; and the prevention of skewing between the lenses and display panels. Further, the invention should contribute to reducing the overall thickness of the display unit. Moreover, the invention should also address the problem of the display being skewed and obstructed due to mismatch between the lens artwork and the display panels.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

The present invention is illustrated by way of example, and not limitation, in the accompanying figures, in which like references indicate similar elements, and in which:

FIG. 1 illustrates a communication device with a display unit, according to an embodiment of the present invention.

FIG. 2 illustrates a pair of lenses and a display assembly, according to an embodiment of the present invention.

FIG. 3 illustrates a lens assembly and a display connector, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF VARIOUS EMBODIMENTS

Various embodiments of the present invention provide a display unit of a communication device. In an embodiment of the present invention, the display unit includes a display assembly, a first lens, and a second lens. The first lens and the second lens are positioned in a spaced apart configuration such that they define an enclosure. In an embodiment of the invention, the display assembly is positioned in the enclosure.

In another embodiment of the present invention a communication device is provided. The communication device includes a display assembly, a lens assembly, a frame, and a control circuit. The display assembly has a first side and a second side. The display assembly is encapsulated in the lens assembly and mounted on the frame. The control circuit controls the display assembly.

Before describing in detail the particular apparatus for display unit of a communication device in accordance with various embodiment of the present invention, it should be observed that the present invention resides primarily in combinations of apparatus and components of the communication device. Accordingly, the apparatus and components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. Since passive antenna is generally equally effective in reception as it is in radiation, of balanced reciprocity, in the text although not explicitly stated, that the word radiation implies including reception.

The term “another,” as used in this document, is defined as at least a second or more. The term “includes” as used herein, are defined as comprising.

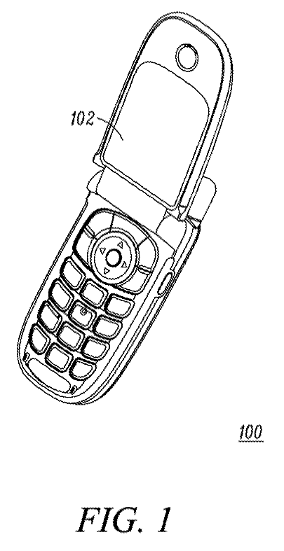

FIG. 1 illustrates a communication device with a display unit, according to an embodiment of the present invention. The figure shows a communication device 100 with a display unit 102. The communication device includes any device having a display. Examples of the communication device 100 may include a mobile phone, a pager, and a Personal Digital Assistant (PDA). Alternate examples of the communication device includes one way communication devices (involving only one human being) like music players, DVD players. The communication device 100 can be of different linear dimensions, measures and shapes, as compared to the one illustrated in the figure. A form factor of a communication device may be defined as its physical shape, pertaining to style and physical measurement. Communication devices are categorized according to form factors such as flip, pager, slide, and candy-bar. The communication device 100 has a flip form factor, which is characterized by a hinge mechanism that separates two halves of the communication device. Most communication devices that employ the flip form factor have two display panels, a main display panel, and a Caller Line Identification (CLI) display panel. The communication device 100 includes a display unit 102. The display unit 102 has a main display panel and a CLI display panel (not shown in figure). The display unit 102 is positioned in the communication device 100. The main display panel is capable of displaying data such as call information, text messages, images and videos. Further, the main display panel is capable of displaying features such as time, wallpapers, battery status, signal strength, caller identity, a phonebook, menu options, phone features, etc. The CLI display panel is located on the same half of the communication device 100 as the main display panel. However, the CLI display panel is located on the opposite side of the main display panel. As the name suggests, the CLI display panel is used for caller information and usually displays less data than the main display panel.

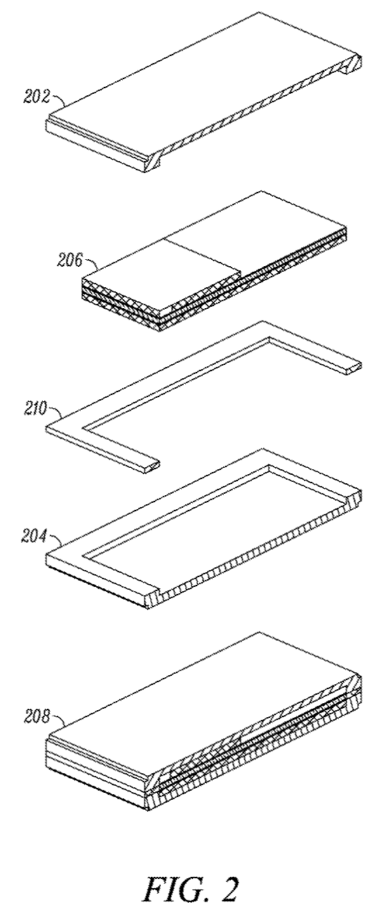

FIG. 2 illustrates a pair of lenses and a display assembly, according to an embodiment of the present invention. The figure shows a first lens 202 and a second lens 204. The first lens 202 and the second lens 204 may be grounded or molded pieces of transparent material. Examples of this transparent material include glass and various plastics. The lenses 202-204 form a cover or protection layer for a display assembly 206, and restrict contact of the display assembly 206 with external elements such as air, dust and other foreign material. Examples of the display assembly 206 include a mobile display panel, a Liquid Crystal Display (LCD), a Light Emitting Diode (LED) display, an Organic Light Emitting Diode (OLED) display, a Field Emission Display (FED), a Flat Panel Display (FPD), and the like. The first lens 202 and the second lens 204 can be positioned together to define an enclosure. The first lens 202 and the second lens 204 are positioned in a spaced apart configuration. The enclosure is created by mating the first lens 202 with the second lens 204. In an embodiment, a gasket 210 can be sandwiched in between the first lens 202 and the second lens 204 to compensate for the tolerance gaps and improve the sealing of the enclosure by providing an air tight sealing to the periphery of the enclosure. In another embodiment, multiple gaskets and/or adhesives can be used between the first lens 202 and the second lens 204 to compensate for the tolerance gaps. The enclosure creates a hollow space between the first lens 202 and the second lens 204 and is capable of accommodating the display assembly 206. The display assembly 206 includes a display element that is capable of displaying textual and graphical information, videos, and the like.

In another embodiment of the present invention, the display assembly 206 may include a main display and a Caller Line Identification (CLI) display. The main display is a front display element present in the communication device 100, and is capable of displaying textual and graphical information, videos, and the like. The main display is also capable of displaying features such as time, battery status, signal strength, caller identity, phonebook, menu options, phone features, wallpapers, etc. The CLI display is a rear display element. The CLI display is capable of displaying selected features of the main display. In an embodiment of the invention, the CLI display is capable of displaying features such as signal strength, caller identity, time, battery status, alarm status, and the like.

In an embodiment of the invention, the display assembly 206 is a single display element. In this embodiment, the single display element includes only the main display. In another embodiment of the invention, the display assembly 206 is a double display element. In this embodiment, the double display element includes the main display and the CLI display. In another embodiment of the present invention, the display assembly 206 may have multiple display elements. The display assembly 206 also includes a light guide assembly, which is sandwiched between the main display and the CLI display. The light guide assembly can include a light guide with multiple optical films. The light guide can be a transparent material to guide light flow by using total reflection. The light guide can be made from plexiglass, plastic, and glass or fiber light guides. A fiber light guide consists of a number of thin light guide fibers. The display assembly 206 is positioned in the enclosure defined by the mating of the first lens 202 and the second lens 204. The enclosure distinctly specifies a sealed hollow housing of the lenses 202-204 and the display assembly 206, to form an integral module 208. The integral module 208 includes the display assembly 206, encapsulated in the first lens 202 and the second lens 204.

In an embodiment of the present invention, the display unit 102 also includes a display connector. The display connector is capable of connecting the electrical circuits of the display assembly 206 to a control circuit of the communication device 100. The display connector can connect to the control circuit with a flexible wire having a connecter at one end. In another embodiment, there can be a fixed opening in the enclosure for connecting the display assembly 206 to the control circuit. The control circuit is capable of controlling the display of the display assembly 206.

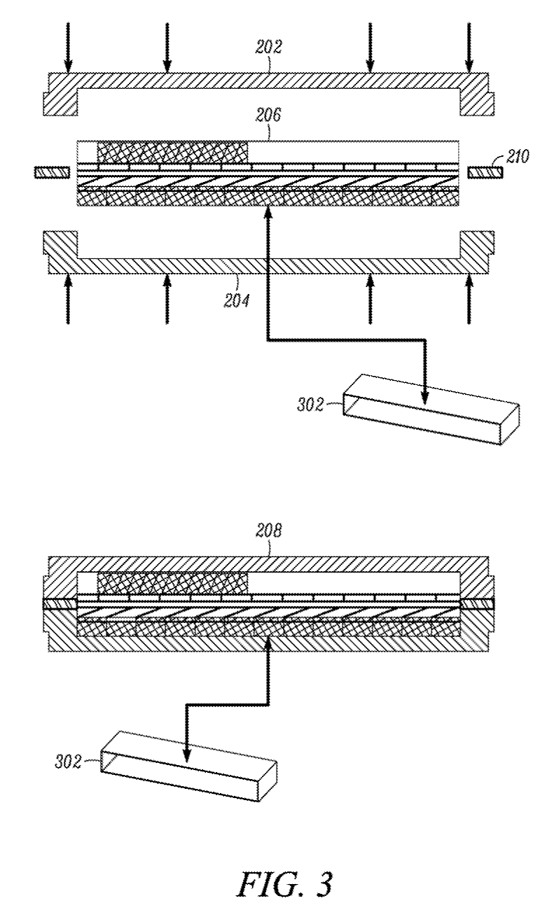

FIG. 3 illustrates a lens assembly and a display connector, according to an embodiment of the present invention. The lens assembly includes the first lens 202 and the second lens 204, configured to form a hollow enclosure. The first lens 202 and the second lens 204 encapsulate the display assembly 206 in the hollow enclosure. The display assembly 206 includes one or more display panels. In an embodiment of the invention, the display assembly 206 has a first side and a second side. The first side has the main display, while the second side has the CLI display. A light guide is positioned between the first side and the second side. This light guide provides a flow of light to the main display and the CLI display.

The first lens 202 holds the display assembly 206 from the first side, such that there is no air gap in between. The second lens 204 locks with the first lens 202 to encapsulate the display assembly 206 from the second side. The first lens 202 and the second lens 204 are locked together using the gasket 210 placed in between the lenses. The gasket 210 runs through the periphery of the lenses 202-204 and forms a complete ring. The gasket 210 provides a layer that seals any gaps arising due to tolerance between the first lens 202 and the second lens 204. The first lens 202 and the second lens 204, with the gasket 210 sandwiched there between are locked together to form a sealed housing. This sealed housing prevents foreign material such as dust, water, air, sand, etc. from entering the display assembly 206. The first lens 202 and the second lens 204, with the display assembly 206, define the integral module 208. The display assembly 206 is connected through a display connector 302. The display connector 302 is used to electrically connect the display assembly 206 with a control circuit of the communication device 100. The control circuit of the communication device 100 transmits display signals to the display assembly 206. The display connector 302 can be placed on the integral module 208. In another embodiment of the invention, the display connector 302 can be a flex connector. This flex connector has a flexible wire, one end of which is connected to the display assembly 206, and other end is left free to be connected to the control circuit.

In an embodiment of the present invention, the communication device 100 has a flip-form factor. The communication device 100 includes a frame for mounting the display assembly 206. The display assembly 206, with the first lens 202 and the second lens 204, can be mounted on the frame. The frame has a structural system to support the integral module 208.

Consequently, the integral module 208 with the display assembly 206, as well as the first lens 202 and the second lens 204 is formed. The integral module 208 with a sandwiched display assembly 206 does not have any air gaps.

The communication device that utilizes the display assembly encapsulated in the sealed hollow enclosure described above will prevent infiltration of dust and other foreign material into the display panel. The hollow enclosure will provide protection from foreign material to the display assembly. Since the lens assembly and the display assembly form an integral module, the possibility of an air gap developing between them is minimized. The integral module, without any air gap, will be thinner, as compared to an integral module with an unwanted air gap. In addition the present display assembly provides for a single gasket to compensate for tolerance gaps, while existing technologies use multiple gaskets for the same. The use of a single gasket as opposed to multiple gaskets further ensures the sleekness of the display unit. Further, the integration of the lenses with the display assembly excludes any possibility of a mismatch between the lens assembly and the display assembly with the lens artwork and main housing of the communication device. This ensures that the skew and obstruction problem, due to separate lenses, is avoided.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A display unit of a communication device, comprising:
a first lens;
a second lens connected to the first lens, wherein the first lens and the second lens are positioned in a spaced apart configuration and define an enclosure; and
at least one display assembly positioned in the enclosure.

2. The display unit as recited in claim 1, wherein the at least one display assembly is a single display element.

3. The display unit as recited in claim 1, wherein the at least one display assembly is a double display element.

4. The display unit as recited in claim 3, wherein the display assembly comprises:
a main display;
a caller line identification display (CLI); and
a light guide positioned between the main display and the CLI display.

5. The display unit as recited in claim 1, further comprising a display connector, the display connector adapted to connect the at least one display assembly to a control circuit of the communication device.

6. The display unit as recited in claim 5, wherein the display connector is positioned in the enclosure.

7. The display unit as recited in claim 5, wherein the display connector is a flex connector, and wherein the flex connector protrudes from the enclosure.

8. The display unit as recited in claim 1, wherein the first lens, the second lens and the at least one display assembly form an integral module, and wherein the first lens and the second lens are positioned against the display assembly such that there is no air gap located there between.

9. A communication device display, comprising:
a lens assembly including a first lens and a second lens, the first lens and the second lens being connected to form a sealed hollow housing; and
at least one display assembly encapsulated within the sealed hollow housing.

10. The communication device display as recited in claim 9, further comprising a display connector to connect the at least one display assembly to a control circuit.

11. The communication device display as recited in claim 9, wherein the at least one display assembly comprises one or more displays.

12. The communication device display as recited in claim 11, wherein the at least one display assembly further comprises a light guide positioned between the one or more displays.

13. A communication device comprising:
a display assembly having a first side and a second side;
a lens assembly, the lens assembly encapsulating the display assembly;
a frame for mounting the display assembly; and
a control circuit for controlling the display assembly.

14. The communication device as recited in claim 13, wherein the display assembly further having a light guide positioned between the first side and the second side.

15. The communication device as recited in claim 13, wherein the lens assembly comprises:
a first lens, the first lens covering the first side of the display assembly; and
a second lens, the second lens covering the second side of the display assembly.

16. The communication device as recited in claim 15, wherein the first lens and the second lens define an enclosure.

17. The communication device as recited in claim 15, wherein the first lens and the second lens are positioned against the display assembly to form an integral module such that there is no air gap there between.

18. The communication device as recited in claim 17, wherein the first lens and the second lens are positioned using a gasket.

19. The communication device as recited in claim 17, wherein the integral module comprises a display connector for connecting the display assembly to the control circuit.

20. The communication device as recited in claim 13, wherein the communication device has a form factor that can be selected from a group comprising flip, pager, slide and candy-bar.
